(19) United States
(12) Patent Application Publication
(10) Pub. No.: US 2024/0360012 A1
(43) Pub. Date: Oct. 31, 2024

(54) SYSTEMS AND METHODS FOR SEPARATING AND/OR REMOVING WATER SOLUBLE ORGANICS FROM AQUEOUS STREAMS

(71) Applicant: WP&E Technologies Solutions, LLC, Flowery Branch, GA (US)

(72) Inventor: Harikrishnan Parthasarathy, Flowery Branch, GA (US)

(21) Appl. No.: 18/648,127

(22) Filed: Apr. 26, 2024

Related U.S. Application Data
(60) Provisional application No. 63/636,793, filed on Apr. 21, 2024.
(60) Provisional application No. 63/462,155, filed on Apr. 26, 2023.

(51) Int. Cl. C02F 1/461; C02F 1/34; C02F 1/467; C02F 101/30; C02F 103/10

(52) U.S. Cl. CPC C02F 1/46109; C02F 1/34; C02F 1/4672; C02F 2001/46142; C02F 2001/46147; C02F 2101/30; C02F 2103/10; C02F 2201/4613

(57) ABSTRACT

Systems and methods for removing water soluble organics from an aqueous stream is provided. In one embodiments a system comprises an electro-oxidation unit comprising a titanium anode comprising a mixed metal oxide (MMO) coating, a titanium cathode, a channel between the anode and the cathode, and a power source configured to apply electricity across the channel.

### RELATED APPLICATION DATA

This application claims the priority and benefit of U.S. Provisional Patent Application No. 63/462,155 filed on Apr. 26, 2023 and U.S. Provisional Patent Application No. 63/636,793 filed on Apr. 21, 2024, the contents of each of which are herein incorporated by reference in their entirety.

### FIELD

The technology described herein generally relates to systems, processes, and methods for separating and/or removing water soluble organics from aqueous stream, and more particularly to separating and/or removing water soluble organics from aqueous streams using electro-oxidation techniques.

### BACKGROUND

In some industrial processes, such as extracting oil and/or gas at offshore sites, produced water that is pumped from production facilities, such as remote or offshore oil wells, has concentrations of water soluble organics. In some instances, the produced water or discharge water produced as a part of overall extraction or processing of oil and/or gas can have a significant water soluble organics (WSO) concentration or can further be acidic, for example due to conventional methods and systems for removing WSOs which utilize acids and implement processes which may cause an acidic byproduct.

As will be appreciated, emissions from industrial processes into natural environments, such as the ocean, are becoming increasingly regulated. In recent years the U.S. Environmental Protection Agency has even for example utilized satellite enforcement of environmental regulations on offshore platforms to detect unacceptable levels of emissions.

Accordingly, there is a need in the art for systems and methods for removing water soluble organics from aqueous streams, particularly in applications where the aqueous streams are discharged into another environment, for example a natural environment.

### SUMMARY

This summary is provided to introduce a selection of concepts or aspects in a simplified form that are further described below in the detailed description. This summary is not intended to identify key features or essential features of the claimed subject matter, nor is it intended to be used in isolation as an aid in determining the scope of the claimed subject matter.

Certain aspects according to the present disclosure are directed towards systems and methods for removal of WSOs from an aqueous stream.

In one aspects a system is provided for removing water soluble organics from an aqueous stream, comprising a titanium anode comprising a mixed metal oxide (MMO) coating, a titanium cathode, a channel between the anode and the cathode, and a power source to apply electricity across the channel, or to the anode and/or cathode.

In some aspects the system is formed into a cartridge configured for reversing polarity of the electrodes.

In some aspects the system is formed into a replaceable cartridge.

In some aspects the system comprises a plurality of anodes and a plurality of cathodes.

In some aspects the MMO coating is iridium oxide.

In some aspects the MMO coating comprises iridium oxide, ruthenium oxide, tantalum oxide, and platinum oxide.

In some aspects the titanium cathode comprises an MMO coating.

In some aspects a voltage of 5-10 V is applied across the channel.

In some aspects a current of 10-25 amps is applied across the channel.

In some aspects the polarity of the anode and the cathode are configured to be periodically switched.

The following is context and development history that is described in greater detail herein, in the Detailed Description: “discharge water” (e.g., water volumes or streams periodically or continuously discharged to the sea or other body(ies) of water) that is emitted from “produced water” or “dirty water” production facilities and/or from “produced water” or “dirty water” processing facilities, and/or that is likely to have a significant water soluble organics concentration, is highly regulated or becoming highly regulated. Moreover, the “discharge water that is emitted from remote, “dirty water” production facilities, for example, from off shore oil or gas platforms; or that is likely to have a significant water soluble organics concentration; or that is likely to be acidic, is highly regulated or becoming highly regulated.

In some aspects, oil or gas wells are considered “dirty water” “production facilities” in that they mainly or primarily produce/extract water that is not readily obtainable or that has been sequestered in a substrate or material, and that happens to have a small but economically valuable fraction that is oil and gas.

In some aspects, removing, capturing, and redirecting the oil and/or gas fraction is often time associated with one or more related industrial channels-of-trade, and/or associated with specific regulations and understandings of what is acceptable.

In some aspects, processing “dirty water”, e.g., what remains of the “produced water” after processing for the oil and gas, is often times associated with its own, different industrial channels-of-trade and/or with different regulations and understandings of what is acceptable.

Development of some aspects according to the present disclosure can be outlined as follows: a conventional electro-oxidation/electrocoagulation system/process is provided. For example, an anode and cathode connected to a voltage source. In some aspects, the anode and/or the cathode are aluminum. In some aspects, if metals, oils, or water soluble organics are in the dirty water, for example, then flocculation will occur with some floc falling out of solution and settling at the bottom of a reaction tank, for example.

In some aspects, there are deficiencies, e.g., (1) requires replacement electrodes because the aluminum anode and/cathode are consumed by the electro-oxidation reaction (aluminum in solution is toxic and a regulated contaminant, so introducing it into the dirty water stream is less than preferred); (2) produces quantities of hydrogen gas which, for a remote facility like an offshore oil or gas platform, is considered to be extremely dangerous (this is due to the need for managing and channeling the hydrogen gas that is produced and the associated explosion risk); (3) requires large quantities of supplies, like filter media and aluminum electrodes, and space to store and stage the supplies, and space to store and package the material wastes (e.g., space to store, package, and ship saturated filter-media laden with highly concentrated contaminants) (if dealing with a remote facility like an offshore oil or gas platform, then it also requires periodic and consistent transportation and restocking of supplies, and requires handling and shipping of material wastes, and then the associated logistics and processing infrastructure to manage those shipped supplies/waste); (4) requires relatively large quantities of labor to manage reaction tank maintenance and upkeep (e.g., to maintain and clean reaction tanks, and to replace electrodes), to manage filter media exchanges, to manage supply stocking and processing, and to manage waste processing and shipping (if dealing with a remote facility like an offshore oil or gas platform, then it also requires having a crew that is willing and able to handle all of the usual tasks of field work plus the added tasks described above); and (5) for those situations where the produced/dirty water that is being processes is acidic or has been acidified, then the systems and sub-systems will also have to be maintained, due to the effects of corrosion, or treated to prevent corrosion (this magnifies the above listed issues, e.g., more supplies, more labor, more work).

In some aspects, an electro-chlorination system/process is provided. For example, a titanium anode and titanium cathode connected to a voltage source. In some aspects, the anode alone is coated in a mixed metal oxide, namely, iridium oxide (a type of mixed metal oxide). In some aspects, the voltage/current is typically about 5-10 V DC and about 25 amps. In some aspects, if metals, oils, or water soluble organics are in the dirty water, for example, then the system/process will produce hydrogen gas, molecular halogen (e.g., fluorine gas, chlorine gas, bromine gas, iodine gas), for example, and/or associated halide compounds or complexes (e.g., fluoride compounds or complexes or mixtures, chloride compounds or complexes or mixtures, bromide compounds or complexes or mixtures, iodide compounds or complexes or mixtures).

In some aspects, there are deficiencies, e.g., (1) requires replacement electrodes (the cathode, in particular) in a short period of time (e.g., about two days), and/or maintenance of electrodes (the anode, in particular) in a short period of time (due to rapid electrode fouling/scaling); (2) produces quantities of chlorine gas and/or bromine gas which, for a remote facility like an offshore oil or gas platform, is considered to be extremely dangerous (this is due to need for managing and channeling the chlorine gas and/or bromine gas that is produced and the associated corrosion/health risks); (3) requires space to store and stage the supplies, like replacement titanium cathodes, and space to store and package the material wastes (e.g., solids removed and collected from defouling/descaling the coated titanium anodes) (if dealing with a remote facility like an offshore oil or gas platform, then it also requires periodic and consistent transportation and restocking of supplies, and requires handling and shipping of material waste, and then the associated logistics and processing infrastructure to manage those supplies/waste); and (4) requires relatively large quantities of labor to manage reaction tank maintenance and upkeep (e.g., to maintain and clean reaction tanks, and to replace electrodes), to manage supply stocking and processing, and to manage waste processing and shipping (if dealing with a remote facility like an offshore oil or gas platform, then it also requires having a crew that is willing and able to handle all of the usual tasks of field work plus the added tasks described above) (if dealing with a remote facility like an offshore oil or gas platform, then it also requires generating and maintaining significant electricity production for the 5-10 V DC/25 amp electro-oxidation system/process).

In some aspects, an electro-oxidation system/process including: a titanium anode coated with platinum, and a mixed metal oxide combination having two or more of ruthenium oxide, iridium (IV) oxide, tantalum oxide, or any combination thereof, is provided. For example, a mixed metal oxide, titanium anode and a titanium cathode connected to a voltage source. In some aspects, the mixed metal oxide, titanium anode is specifically coated in a mixed metal oxide combination (two or more mixed metal oxides, namely, those having rare earth metal elements) and platinum (distinguished from platinum oxide; platinum is a noble metal). In some aspects, the voltage/current is typically about 3 V DC and about 25 amps. In some aspects, if water soluble organics are in the dirty water, for example, then the system/process will convert water soluble organics into free oil (available for recovery) without need for acid treatment to the dirty water. In some aspects, the process/system only produces quantities of generally harmless carbon dioxide gas (e.g., hydrocarbons) as well as generated H2O (clean water) with no added toxicity to the dirty water or discharge water, and/or with no added acidity needed. In some aspects, if dealing with a remote facility like an offshore oil or gas platform, then the process/system demands significantly less electricity over time than the 5-10 V DC/25 amps conventional systems/processes.

In some aspects, an electro-oxidation system/process including a coated titanium anode and an equivalently coated titanium cathode connected to a voltage source is provided. For example, the anode and the cathode are coated in a mixed metal oxide, namely, any of ruthenium oxide, iridium (IV) oxide, tantalum oxide, or those listed above and herein. In some aspects, the process/system requires replacement electrodes but only after a significantly longer period of time (e.g., about one (1) year); requires significantly fewer types of supplies and less quantities of supplies, like filter media and replacement electrodes, and requires significantly less space to store and stage the supplies (if dealing with a remote facility like an offshore oil or gas platform, requires significantly fewer trips and less logistics for transportation and restocking of supplies); and requires significantly less labor to manage the systems/processes.

In some aspects, an electro-oxidation system/process including a mixed metal oxide and platinum, titanium anode, and a mixed metal oxide and platinum, titanium cathode connected to a voltage source is provided. For example, the mixed metal oxide and platinum, titanium electrodes each may specifically include a mixed metal oxide combination (two or more mixed metal oxides, namely, two or more of ruthenium oxide, iridium (IV) oxide, tantalum oxide, or those listed above and herein, or any combination thereof). In some aspects, reversed polarity is used to defoul/descale the electrode that was once the anode and is now the cathode (after the reversal of polarity), such that the system/process does not have to be shut down or bypassed. In some aspects, the electrodes are configured as a selectively replaceable cartridge that it is an easy replacement piece when the electrodes reach the end of their useful life. As such, the system/process is consistent in producing efficient and effective results (e.g., acceptable discharge water) even during maintenance and upkeep. Moreover, the system/process has a reduced size and footprint, a reduced weight, and a reduced capital expenditure and operating cost.

Additional objects, advantages, and novel features of the invention will be set forth in part in the description which follows, and in part will become apparent to those skilled in the art upon examination of the following, or can be learned by practice of the invention.

### BRIEF DESCRIPTION OF THE DRAWINGS

Aspects of the present disclosure can be better understood with reference to the following drawings. The components in the drawings are not necessarily to scale, with emphasis instead being placed upon clearly illustrating the principles of the disclosure. Aspects of the technology presented herein are described in detail below with reference to the accompanying drawing figures, wherein:

FIG. 1 illustrates an example oil, gas, and water production process, in accordance with some aspects of the technology described herein;

FIG. 2 illustrates an example operational method for water soluble organics (WSO) removal and/or separation, in accordance with some aspects of the technology described herein;

FIG. 3 illustrates example electrodes and electrode arrays, in accordance with some aspects of the technology described;

FIG. 4 illustrates an example electro-oxidation component, in accordance with some aspects of the technology described herein;

FIG. 5a illustrates an example electro-oxidation component, in accordance with some aspects of the technology described herein;

FIG. 5b illustrates an example electro-oxidation component, in accordance with some aspects of the technology described herein;

FIG. 6 illustrates a flow diagram of an example electro-oxidation system, in accordance with some aspects of the technology described herein;

FIG. 7 illustrates example aspects of an electro-oxidation separation system with electrode reaction chemistry, in accordance with some aspects of the present technology;

FIG. 8 illustrates a diagram of an example electro-oxidation system, in accordance with some aspects of the present technology;

FIG. 9 illustrates example electro-oxidation systems, in accordance with some aspects of the present technology;

FIG. 10 illustrates an example electro-oxidation system, in accordance with some aspects of the present technology;

FIG. 11 illustrates an example produced water treatment (Total Oil and Gas and WSO Removal Facility) system, in accordance with some aspects of the present technology;

FIG. 12 illustrates an example configuration of a produced water treatment system, in accordance with some aspects of the present technology;

FIG. 13 illustrates an example configuration of a produced water treatment system, in accordance with some aspects of the present technology;

FIG. 14 graphically illustrates WSO removal implementing electro-oxidation systems, in accordance with some aspects of the present technology;

FIG. 15 illustrates an example of a hydrodynamic cavitation assisted advanced oxidation process, in accordance with some aspects of the present technology; and

FIG. 16 illustrates an example schematic of a hydrodynamic cavitation process for flow characteristics, in accordance with some aspects of the present technology.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps disclosed herein unless and except when the order of individual steps is explicitly described.

Accordingly, embodiments described herein can be understood more readily by reference to the following detailed description, examples, and figures. Elements, apparatus, and methods described herein, however, are not limited to the specific embodiments presented in the detailed description, examples, and figures. It should be recognized that the exemplary embodiments herein are merely illustrative of the principles of the invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

In some aspects, embodiments of the present technology generally relate to chemical processes or systems, more particularly, to processes, systems, and methods for removing water soluble organics (WSOs) from aqueous streams, such as in industrial processes or systems, or from produced water (e.g., dirty water from oil wells). As used herein, WSO's may in some instances refer to dissolved organics or hexane extractable organics. In some aspects, embodiments generally relate to chemical processes, methods and/or systems to separate WSOs from aqueous streams in industrial processes or systems, or from produced water. In some aspects, embodiments generally relate to chemical processes, methods and/or systems to convert water soluble organics in aqueous streams to free oils and/or dispersed oils. In some aspects, embodiments generally relate to chemical processes, methods, and/or systems to remove strong oily water emulsions and water soluble oily components from produced and process wastewater. In some aspects, embodiments generally relate to chemical processes, methods, and/or systems to break aromatics, cyclic organics, saturated or unsaturated gasoline and diesel range organics into saturated or semi saturated long chain organics. In some aspects, embodiments generally relate to chemical processes, methods, and/or systems, to negate negative colloidal charges (which breaks emulsions) and allows for agglomeration of saturated or semi saturated long chain organics (for example, into a suspended or free phase layer). In some aspects, embodiments generally relate to chemical processes, methods, and/or systems to increase the commercial longevity of an oil well (e.g., offshore oil well) by increasing the total oil and gas possible from a produced water stream from the oil well.

At a high level, embodiments of the present technology are directed towards processes, systems, and methods for removing water soluble organics (WSOs) from aqueous streams, for instance contaminated aqueous streams. For example, in some instances, a contaminated stream can be a discharge water stream that is emitted from produced water, sometimes referred to as dirty water, from industrial production or processing facilities, for example from oil or gas wells or from systems associated with or related to oil or gas wells. In some instances, water produced in these processes or that are considered discharge water, for example water volumes or streams that are periodically or continuously discharged from these facilities (e.g. the ocean), can in some instances have a high water soluble organics WSOs concentration or a high amount of WSOs.

In some aspects, embodiments of the technology described herein can provide multiple benefits compared to conventional systems, for instance, implementation of systems and/or processes described herein can reduce or shorten residence time of water in the system, not require pH adjustment (e.g. no acid addition which in some instances cause corrosion issues), not require media-based operation (e.g. no need for adsorbent/absorbent), provide for less intensive operations (e.g. lower labor, lower cost, lower maintenance), and provide a compact footprint.

As will be appreciated, oil or gas wells may be considered dirty water production facilities in that in their operation the production and/or extraction of water is a part of the overall industrial process. For example, water may be obtained as a fraction of extracted or process oil and/or gas. In certain industrial processes/systems, where the input materials/intermediate materials are or are associated with fossilized organic matter, the arrangement or compositions of the oil/gas/water separation system and/or the chemical reaction of the industrial process result in “dirty water.” Even with the oil/gas/water separation stage, the dirty water typically still has an unacceptable non-polar concentration and an unacceptable polar concentration, and the dirty water needs to be further handled (whether it be processing it or storing/dumping/emitting it). The non-polar concentration is typically characterized as comprising free oils and/or dispersed oils. The polar concentration is typically characterized as comprising other organic and non-organic contaminants. More specifically, as produced or dirty water is processed and treated by conventional systems and methods, a discharge water stream is created. Depending on industry standards, historical practice, internal or external regulations, and/or the geopolitical and geospatial characteristics defining the oil and gas well, the discharge water may be a point of interest and scrutiny. For example, conventional systems and methods tend to be exceptionally good a removing, capturing, and redirecting the non-polar fraction (e.g., oil and/or gas) of produced water. Even with conventional oil/gas/water separation techniques, the dirty water coming out of the oil/gas/water separation stage typically still has an unacceptable non-polar concentration and an unacceptable polar concentration.

In some aspects, dirty water processing techniques can include separators, hydro cyclones, flotation units, and are used to reduce free oils in what will become discharge water. In some aspects flotation units and media filters, also are used in an attempt to reduce dispersed oils in what will become discharge water.

Unfortunately, despite these processing techniques, the discharge water from these industrial processes/systems can still have a total oil concentration (e.g., non-polar concentration and polar concentration, taken together) or component concentration that exceed regulatory limits (for example, 29.0 parts per million for total oil concentration, USA. Furthermore, even if the discharge water has average contaminant concentrations below the regulatory limits, it is likely that real time contaminants concentrations vary widely (e.g. swing above the regulatory limits) throughout the useful life of these industrial processes/systems and, therefore, the harmful effects of the higher concentrations are not fully mitigated or avoided.

There are multiple reasons this happens. In one example, even if the discharge water has contaminant concentrations that are on average below regulatory limits, it is likely that contaminants have simply been redirected, moved, and/or concentrated into capture media or capture systems and that, when these capture media or capture systems are down/inoperative, or being changed-out, adjusted, maintained, or updated (all of these tend to be periodic and necessary), the discharge water will have contaminant concentrations that are above regulatory limits. In another example, even if the discharge water has contaminant concentrations that are on average below regulatory limits, it is likely that contaminants have simply been redirected, moved, and/or concentrated into capture media or capture systems and that although the discharge water concentrations are low, the concentrations in the emissions coming out of the processing systems for the capture media are above regulatory limits (or unregulated or under regulated). In another example, depending on the source of the fossilized organic matter (e.g., the location of an oil or gas wells), the produced water or dirty water and, therefore, the discharge water from these industrial processes/systems will have water soluble organics concentrations (characterized as polar) greater than what you would otherwise typically expect and that may contribute to overall contaminant concentration(s) that are above regulatory limits. In another example, depending on the tapped age of the fossilized organic matter (e.g., the age of an oil or gas well), the amount of produced water or dirty water extracted from the source will significantly increase and, therefore, the total throughput of these industrial processes/system also must significantly increase (e.g., be capable of scaling) or risk being incapable of managing the increased amount of produced water/dirty water and, consequently, risk having discharge water with contaminant concentrations that are above regulatory limits or a shutdown facility.

For those situations where the source of the fossilized organic matter (e.g., the location of an oil or gas wells) results in produced/dirty/discharge water with elevated water soluble organics concentrations, there may be additional industry conditions and forces that lead to problems and concerns. More specifically, elevated water soluble organics concentrations in produced water may be a source of value. For example, conventional systems and methods for processing produced/dirty water tend to be exceptionally good a removing, capturing, and redirecting the non-polar fraction (e.g., oil and/or gas and/or free oils) of produced water and less good at removing, capturing, and redirecting the water soluble organics fraction. In some conventional systems and methods for making the water soluble organic fraction accessible as free oils in the dirt water; however, they typically involve the addition of acid to the aqueous stream. This can create problems especially for remote facilities (e.g., offshore oil or gas wells) with minimal storage space (both for supplies like concentrated acids or filter media, and for process streams or volumes like tanks or reservoirs), with minimal readily available resources, and with minimal man power (e.g., skeleton crews). Moreover, and unfortunately, despite these conventional dirty water processing techniques, the discharge water from the acidification stage tends to be acidic which creates its own problems (e.g., corrosion issues, environmental issues). As will be appreciated, dirty water is generally not naturally acidic, however, some current conventional methods of water treatment (e.g. removal of water soluble organics) utilize acids which can create a layer of WSOs that can be removed but leaves an acidic byproduct.

Accordingly, systems, processes, and methods described herein overcome conventional systems and methods for removing a polar fraction from a contaminated aqueous stream, and more particularly, for removing water soluble organics (WSOs) from a contaminated aqueous stream.

In one aspect of the present technology, systems and methods are provided for creating a chemical reaction condition/tank/stage that is ideal for remote, “dirty water” production facilities, for example, off shore oil or gas platforms, which are characterized as having: minimal storage space (e.g., that have minimal storage space for supplies like concentrated acid(s), or for replacement filter media for quickly exhausted used filter media, and that have minimal space for by-pass or run-off streams or tanks/reservoirs); minimal readily-available resources (e.g., that have minimal capability to readily accommodate changes in contaminant concentration(s)/dirty water throughput or to accommodate changes in the total quantity of contaminants being processed); and minimal man power (e.g., that have minimal capability to supply man-hours to secondary systems and processes and related tasks).

In one aspect of the present technology, systems and methods are provided for creating a chemical reaction condition/tank/stage that keeps water soluble organics concentrations consistently and continuously (as much as possible) low, and that does not demand significant by-pass or run-off processes/systems/components/stages (or that demands no by-pass or run-off whatsoever) (by-pass or run-off systems/processes would likely cause the discharge water to have periodic/intermittent stretches of time when contaminant concentration(s) are above regulatory limits).

In one aspect of the present technology, systems and methods are provided for creating a chemical reaction condition/tank/stage that doesn't add any extra significant toxicity to the discharge water (especially if the discharge water is flowing directly to ecosystems or population centers, or commercial-use sources).

In one aspect of the present technology, systems and methods are provided for creating a chemical reaction condition/tank/stage that produces the least amount of hydroxyl radicals, as fast as possible (or relatively fast), using the lowest energy consumption possible (or relatively low energy consumption).

According to some embodiments of the present invention, an implementation or pseudo-implementation of an electro-chlorination process utilizing an electro-cell (e.g. electrolyzer), also referred to as an electro-oxidation (EO) unit herein having one or more channels that can be implemented or used for the removal of WSOs from an aqueous stream. In some embodiments, an EO unit can comprise one or more anode-cathode pairs. In some aspects, an anode and/or a cathode can be formed as a plate.

In one aspect, an electro-cell or EO unit comprises a titanium anode and titanium cathode connected to a voltage source. The anode alone can be coated in a mixed metal oxide, for example, iridium oxide (a type of mixed metal oxide). Mixed metal oxide electrodes, also called dimensionally stable anodes, are devices with high conductivity and corrosion resistance for use as electrodes (specifically, anodes) in electrolysis. They are typically made by coating a substrate, such as a pure titanium plate or expanded mesh, with one or several kinds of metal oxides such as ruthenium oxide (RuO2), iridium (IV) oxide (IrO2), or platinum oxide (PtO2), which conducts electricity and catalyzes the reaction. Oxides containing two or more different kinds of metal cations are known as mixed metal oxides. Oxides can be binary, ternary and quaternary and so on with respect to the presence of the number of different metal cations. They can be further classified based on whether they are crystalline or amorphous. If the oxides are crystalline, then the crystal structure can determine the oxide composition. For instance, perovskites have the general formula ABO3; scheelites, ABO4; spinels, AB2O4; and palmeirites, A3B2O8. The different metal cations (MI and MII) are present as MIn+-Ox and MIIn+-Ox polyhedra, which are connected in various possible ways, such as corner or edge sharing, forming chains MI-O-MII-O, MI-O-MI-O or MII-O-MII-O. Therefore, MMO coatings typically consist of an electro-catalytic conductive component that catalyzes the reaction to generate current flow, and bulk oxides (cheaper fill materials) that prevent corrosion of the substrate material (titanium). For cathodic protection applications, one primary electro catalysts that can be used is ruthenium oxide. Other oxides are a mixture of titanium dioxide (TiO2) and tantalum oxide (TaO5). Titanium dioxide and/or tantalum oxide can further provide an oxide film over the substrate material (e.g., the titanium) to prevent corrosion of the substrate.

In some aspects, the voltage/current can be about 5-10 V DC and about 25 amps passed across the channel between an anode and a cathode and/or delivered to the anode and/or cathode.

If metals, oils, or water soluble organics are in the dirty water, for example, then the system/process will produce hydrogen gas, molecular halogen (e.g., fluorine gas, chlorine gas, bromine gas, iodine gas), for example, and/or associated halide compounds or complexes (e.g., fluoride compounds or complexes or mixtures, chloride compounds or complexes or mixtures, bromide compounds or complexes or mixtures, iodide compounds or complexes or mixtures.

In some embodiments of the technology, an electro-oxidation system and/or process is provided that incorporates a titanium anode coated with platinum, and a mixed metal oxide combination having two or more of ruthenium oxide, iridium (IV) oxide, tantalum oxide, or any combination thereof. Mixed metal oxide, titanium anode and a titanium cathode connected to a voltage source. The mixed metal oxide, titanium anode is specifically coated in a mixed metal oxide combination (two or more mixed metal oxides, namely, those having rare earth metal elements) and platinum (distinguished from platinum oxide; platinum is a noble metal). The voltage/current can be about 3 V DC and about 25 amps. In some embodiments, the voltage/current can have a range from about 5-10 V DC and about 25 amps. If water soluble organics are in the dirty water, for example, then the system/process can convert water soluble organics into free oil (available for recovery) without need for acid treatment to the dirty water.

As will be appreciated, the above electro-oxidation system process can in some aspects only produces quantities of generally harmless carbon dioxide gas (e.g., hydrocarbons), generates clean water, does not add toxicity to dirty or discharge water, and does not require the need for the use of acids in treatment of dirty water. If dealing with a remote facility like an offshore oil or gas platform, then it demands significantly less electricity over time than the 5-10 V DC/25 amps conventional systems/processes.

In some aspects, a coated titanium anode and an equivalently coated titanium cathode can be connected to a voltage source (in some aspects herein this can be referred to electro-cell). In some aspects an electrocell can have a plurality of anodes and a plurality of cathodes, or a plurality of anode-cathode pairs. In some aspects the plurality of anodes and cathodes can alternate. In some aspects the distance between anodes and/or cathodes can be the same or can vary or can be tuned based on reaction feedback. In some aspects, the anode and the cathode are coated in a mixed metal oxide, namely, any of ruthenium oxide, iridium (IV) oxide, tantalum oxide, or those listed above and herein. This setup provides multiple advantages including: requires replacement electrodes but only after a significantly longer period of time (e.g., about one (1) year; requires significantly fewer types of supplies and less quantities of supplies, like filter media and replacement electrodes, and requires significantly less space to store and stage the supplies; it requires significantly fewer trips and less logistics for transportation and restocking of supplies; and it requires significantly less labor to manage the systems/processes than conventional systems or processes.

In some other embodiments, mixed metal oxide and platinum, titanium anode, and a mixed metal oxide and platinum, titanium cathode connected can be to a voltage source (e.g. as an electrocell). The mixed metal oxide and platinum, titanium electrodes each specifically include a mixed metal oxide combination (two or more mixed metal oxides, namely, two or more of ruthenium oxide, iridium(IV) oxide, tantalum oxide, or those listed above and herein, or any combination thereof. Dirty water can be passed through a channel of the electrocell and WSOs can be removed.

In some other embodiments, the electrocell can be implemented and reverse polarity can be used, to defoul/descale the electrode that was once the anode and is now the cathode (after the reversal of polarity), such that the system/process did not have to be shut down or bypassed. In this way the system/process to continuously operate without a significant decrease in effectiveness or efficiency, even though the electrode is being maintained. The electrocell can be formed into a replaceable cartridge configuration such that it is an easy replacement piece when the electrodes (which switch from anode to cathode, and cathode to anode depending on direction of the current/polarity) reach the end of their useful life.

In some aspects, an electrocell or electro-oxidation (EO) unit can be configured to operate in the range of 10-70 mA/cm² across an anode-cathode pair. In some aspects, 10-70 mA/cm² can be applied across one or more anode-cathode pairs, or across an electrode array. In some aspects, an electrocell can be configured to operate at above 70 mA/cm². In some instances, the (EO) unit can operate at a voltage of 0.5-10 V. In some instances, the (EO) unit can operate at a voltage of 1-10V.

In some aspects, the cathode can be Ti, can be MMO coated Ti, and/or can be Ti Boron doped diamond film coated. In some aspects, the anode can be Ti, MMO coated Ti, and/or can be Ti Boron doped diamond film coated.

In some aspects, when in operation the polarity of at least an anode cathode pair can be reversed (e.g. designating the anode as the cathode and the cathode as the anode). The polarity may be reversed for any period of time not inconsistent with the present disclosure. In some aspects, the polarity may be reversed back to the original configuration.

In some aspects, an EO system can comprise one or more EO units. In some embodiments where two or more EO units are in operation, the parameters of each, and/or including polarity, can differ or be the same.

In some embodiments, a system comprising an EO unit can incorporate one or more hydrodynamic cavitation (HC) units. In some instances, an HC unit can be located before an EO unit. In some instances, an HC unit can be located after (e.g. downstream) from an EO unit. Any cavitation device not inconsistent with the present technology can be implemented in methods and systems disclosed herein.

As will be appreciated, treatment of organic contaminants in wastewater has always been a great challenge in terms of efficiencies and costs. Emerging technologies such as Advanced Oxidation Process (AOPs), which harness the reactivity of hydroxyl/peroxygen radicals for organic contaminant mineralization has gained significant attention for many years. Cavitation methods, though considered a nuisance in flow systems, have shown great potential in wastewater treatment. In particular, hydrodynamic cavitation (HC), which is the formation of cavitation bubbles when a liquid is subjected to dynamic pressure reduction due to the presence of constriction in the flow system, has generated substantial interest due to their efficacy. The advantage of using HC based treatment technology is the fact that no additional capital equipment is required. It allows for slight modification of existing treatment systems to achieve better contaminant removal efficiencies. The mechanism of HC is based on pressure/temperature driven generation of hydroxyl (OH·) radicals. The cavity created downstream of constriction creates intense turbulence, liquid streaming at micro level as well as hot spots, which in turn generates significant amounts of hydroxyl radicals or peroxygen radicals required for organic pollutant degradation. Hydrodynamic cavitation when operated at the correct optimized conditions establishes the continuous generation of free radicals with maximum contact between the radicals and the pollutants in the shortest possible time. Thus, it reduces: (1) operational costs, (2) requirement for additional chemicals, (3) energy requirements and allows for effective treatment of large amounts of wastewater. It is typically estimated that effective hydrodynamic cavitation reduces operational costs by at least 50%. In one aspect, the key to the successful implementation of the technology is: (a) physiochemical properties of the fluid, (b) chemical substance to be degraded and; (c) type and geometry of the cavitation device.

In one aspect, a Hydrodynamic Cavitation Based Wastewater Treatment was developed, in particular, a HC-based process effluent treatment technology, for a petrochemical company discharging propylene glycol in the effluent. The process reduced the glycol concentration from 500 mg/L to ˜150 mg/L (discharge limit of 250 mg/L), and the TOC from ˜250 mg//L to 75 mg/L.

The typical design of a HC-unit is shown in the FIGS. The geometry of the cavitating device affects the intensity of cavitation and, therefore, the efficiency of the HC process. A proper design for the fluid flow through the constriction is required as it influences pressure conditions during flow, thus the cavitation number and the intensity of the cavities generated. Additionally, constrictions should be located at appropriate positions such that enough cavities are generated for efficient degradation of the pollutant. The cavitating devices that are commonly used includes throttling valves, venture, orifice plates, high-speed rotors, homogenizers, and vortex-diodes.

In one aspect, a HC unit is a vortex diode-based unit, which will is modified to include an orifice plate-based unit. The wastewater contains 60% ethylene glycol, 40% propylene glycol (total glycol concentration ranging from 1000-10,000 mg/L). The total dissolved solids (TDS) will be comprised of 60% sodium chlorides, 10% sodium carbonate and 30% sodium sulfate. The TDS of the wastewater will be maintained at 30,000 mg/L (ppm).

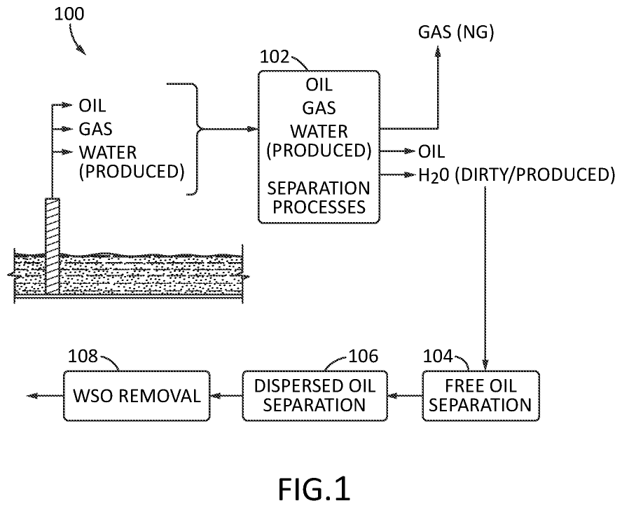

Referring now to the FIGs, FIG. 1 illustrates various aspects of an example oil, gas, and water production process 100, in accordance with some aspects of the technology described herein. In the production of oil and/or gas, particularly in an offshore environment, a well can produce or pump oil, gas, and water components (e.g. produced water, dirty water), among others. A combined stream of pumped materials from a well can be passed through one or more separation processes to separate the oil, gas (e.g. natural gas), and water. As will be appreciated, in some instances, the produced or dirty water may further contain oil (either as free oil and/or dispersed oil) which can be further removed from the water. In some instances, separated out water can further be processed in a free oil separation unit (e.g. separator, hydrocyclones, flotation units) or separation process 104 and/or a dispersed oil separation unit or separation process 106 (e.g. floatation units, media filtration). As will be appreciated, total oil in the produced water can include free oil (as a non-polar fraction percent) and a water soluble fraction (as a polar fraction) which may be dispersed oils and/or WSOs. As another stage, after free oil and dispersed oil are removed and/or recovered, WSOs can be removed from the aqueous stream, for instance prior to discharging water back into the sea (that is the process removes oils and WSOs below a threshold amount for discharge). This stage can be implemented as a WSO removal unit 108, stage, or removal process (e.g. carbon filters, media, electro-cell etc.).

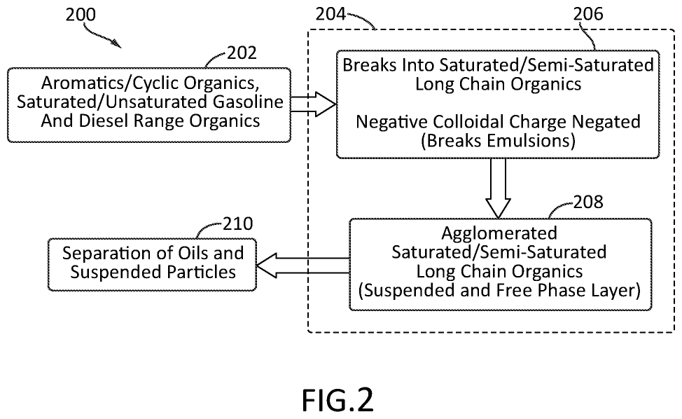

Referring to FIG. 2, an example operational method for WSO removal and/or separation 200 is illustrated. An aqueous stream (e.g. produced or dirty water) 202 containing, among other components, aromatics/cyclic organics, saturated/unsaturated gasoline, and/or diesel range organics can be passed into an electro-oxidation unit and/or system 204, such as a unit or system described herein. At step 206 an electro-oxidation unit and/or system can receive an aqueous stream (in either batch, plug, or continuous flow) and break organics into saturated/semi-saturated long chain organics, or further break emulsions and/or negate or revers negative colloidal charges of organic particulates. Further, within electro-oxidation unit and/or system 204 at step 208 agglomerated saturated/semi-saturated long chain organics can be formed (both in suspended and free phase layers). At step 210 separation of oils and suspended particles flowing out of electro-oxidation unit and/or system 204 can be carried out, for example in on or more separation or filtration steps.

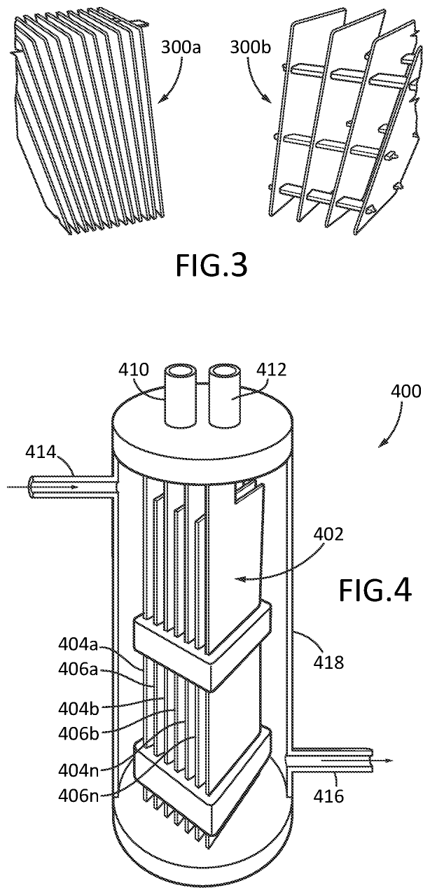

Turning now to FIG. 3, FIG. 3 illustrates example electrode arrays 300a, 300b, comprising two or more electrodes, in accordance with some aspects of the technology described herein. As shown, an electrode array can be utilized in or as a part of an electro-oxidation system, component, and/or unit, as described herein. As electrode array can comprise two or more electrodes, which may be electrode pairs (i.e. anode-cathode) pairs. In some aspects, an electrode array comprises a plurality of anodes and a plurality of cathodes. In some aspects an electrode array comprises alternating electrodes (e.g. anode-cathode-anode-cathode, etc.). In some aspects, an electrode array can comprise a plurality of electrode pairs. Anodes(s) and/or cathodes(s) that form an electrode array can be formed of any shape not inconsistent with the objectives of the present technology. In some aspects, the electrode(s) can be formed into a rod or a plate. In some embodiments, at least a portion of the anode(s) and/or cathode(s) of an electrode array can be coated. In some embodiments, at least a portion of the anode(s) and/or cathodes can remain uncoated or untreated.

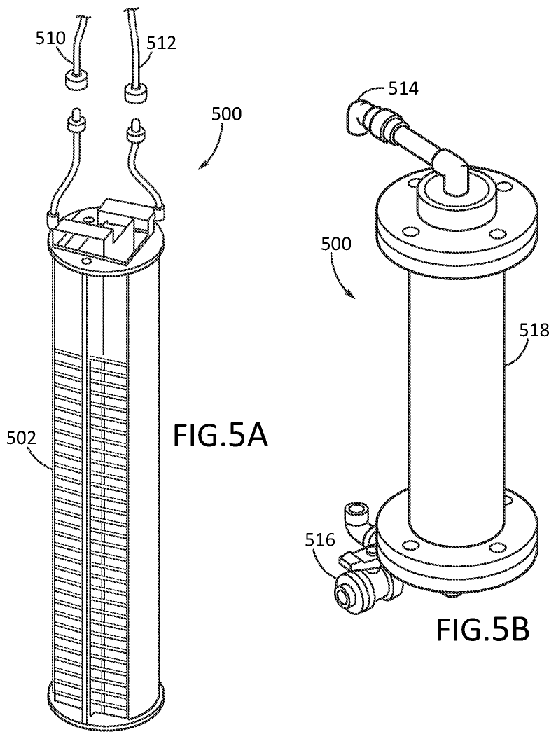

FIG. 4 illustrates an example electro-oxidation component, system, or electro-oxidation unit 400, in accordance with some aspects of the technology described herein. As will be appreciated, multiple electro-oxidation units or components may be utilized in a system for removing WSOs, for example multiple electro-oxidation (EO) units may be placed in parallel or in series along a flow of an aqueous stream requiring WSO removal. In some aspects, an EO unit can include an electrode array 402 made up of at least two electrodes (e.g. anode 404a and cathode 406a). As will be appreciated, an electrode can be formed into or implemented as any shape no inconsistent with the technical objectives of the present technology, for instance a square or rectangular plate, a rod, etc. In some instances, electrode array 402 can comprises a plurality of electrodes, such as anodes 404a, 404b, 404n, and corresponding cathodes 406a, 406b, 406n. In embodiments, an EO unit can have from 2-100 electrodes, which can in some instances be configured as plates. An EO unit can have between 2-90 electrodes, 2-80 electrodes, 2-70 electrodes, 2-60 electrodes, 2-50 electrodes. In some embodiments, an EO unit can have between 50-100 electrodes. In some embodiments, the electrodes of an electrode array can be spaced in any manner not inconsistent with the technology described herein. In some embodiments, the gap between consecutive electrodes can be the same or can vary (i.e. inter-electrode spacing). In some embodiments, the gap (or spacing) between electrodes and/or consecutive electrodes can be from about 2 mm to about 60 mm, about 5 mm to 50 mm, about 10 to 40 mm, or about 15 to 30 mm. In some embodiments the gap can be from about 2 to 10 mm, from about 2 to 5 mm, or about 5 to 20 mm.

In some embodiments an electrode pair or in some instances an electrode array 402 can be contained in a housing 418, for example a pipe, tank, or vessel. In some embodiments, multiple electrode arrays may be disposed within a housing or tank. An electrode array 402 can be connected to a voltage source, for example a positive and a negative terminal, such as terminals 410 and 412. One or more positive terminals 410 can be connected (or in operable communication with) to the one or more positive electrodes (i.e. cathodes) and the one or more negative terminals 412 can be connected to (or in operable communication with) the one or more negative electrodes (i.e. anodes). In some embodiments an EO unit can have one or more inlets 414 and one or more outlets 416, which are configured to enable the passage of an aqueous stream through the EO unit. In some embodiments EO unit can comprise inlets 416 and outlets 414. In some embodiments, during operation an outlet can be closed or restricted to allow an aqueous stream to fill an EO unit for a determined residence time. In some embodiments, an aqueous stream can have a residence time within an EO unit. In some instances, the residence time in an EO unit can be from about 30 seconds to about 4 minutes. In some instances, the residence time can be from about 30 seconds to about 2 minutes. In some instances, the residence time can be from about 30 seconds to about 3 minutes, or from about 1 minutes to about 3 minutes. In some aspects, the parameters corresponding to an EO unit (e.g. residence time, gap between electrodes, number of electrodes, and/or electrode coating) can be tuned based on a desired hydroxyl radical production. In some embodiments, systems descried herein only require a single pass through one or more EO units to remove or separate WSOs from an aqueous stream to below a threshold amount.

FIG. 5a and FIG. 5b further illustrate aspects of an example electro-oxidation component and/or unit, in accordance with aspects of the present technology. Accordingly, an EO component and/or unit 500 can comprise an electrode array 502 comprising two or more electrodes. Electrodes and/or electrode array 502 can be operatively coupled or in communication with a power source, for instance via a positive and negative terminal 510, 512. In some aspects, electrode array 502 can be formed into a cartridge and further be contained in a housing 518. In some aspects, housing 518 can be a non-conductive material such as a thermoplastic or polymeric material. In some further aspects, EO component and/or unit 500 can comprise an inlet 514 (or one or more inlets) and an outlet 516 (or one or more outlets). As will be appreciated, an inlet and an outlet can be positioned anywhere on a vessel or housing that is not inconsistent with the technical objectives of the technology.

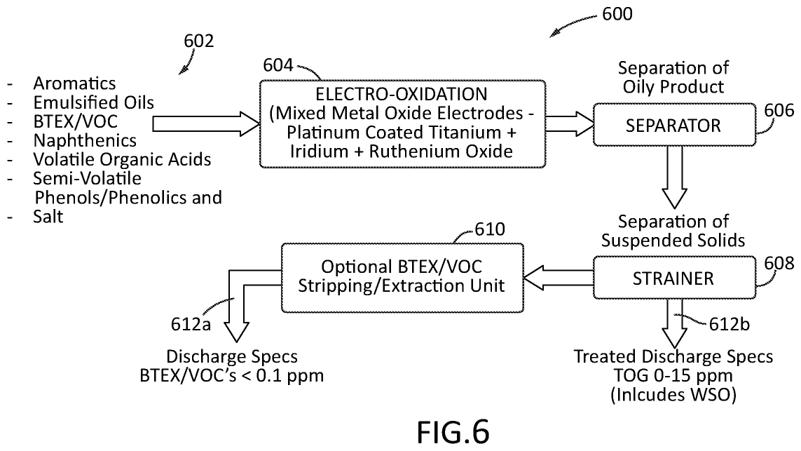

FIG. 6 illustrates a flow diagram of an example electro-oxidation system, or electro-oxidation separation and/or removal system 600, in accordance with some aspects of the technology described herein. At step 602, produced and/or dirty water (i.e. aqueous stream) can enter a system at an inlet for separation and/or removal of WSOs. At an inlet 602, an aqueous stream can comprise one or more WSOs that are solubilized in water. At step 604, an electro-oxidation unit, or multiple units, can be implemented to react with WSOs in the aqueous stream convert the water soluble organics into water insoluble materials, for example through the production of hydroxyl radicals. As will be appreciated, the operational parameters of an electro-oxidation unit 604 (e.g. residence time, number of electrodes, gap between electrodes, volumetric and/or size parameters of each electro-oxidation unit) can be tuned to produce enough hydroxyl radicals to convert the WSOs into water insoluble species. Furthermore, the operational parameters of an electro-oxidation unit 604 can be tuned to ensure that hydroxyl production remains low enough so as to not generate and/or prevent unwanted byproducts. Subsequent to converting via reaction WSOs into water insoluble species, an aqueous stream (i.e. containing water insoluble species) can pass through one or more additional separation and/or removal units, such as a separator 606, strainer 608, and/or a stripping/extraction unit 610. Subsequently, cleaned or treated water can leave the system by way of one or more streams 612a, 612b, where contaminants are reduced and/or removed and/or separated. As will be appreciated, some further aspects of an electro-oxidation system are provided for in U.S. application Ser. No. 17/327,781, titled System for Quick Response, Transportable, Stand-Alone System for Removing Volatile Compounds from Contaminated Fluid Streams, and Method of Use Therof, the contents of which are incorporated by reference herein in their entirety.

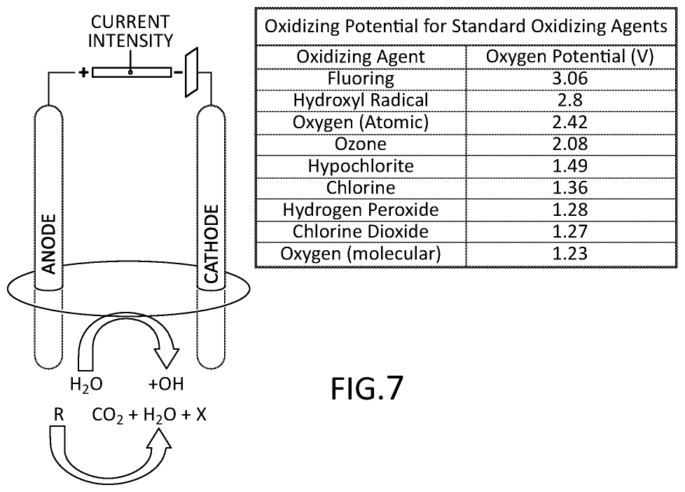

FIG. 7 illustrates example aspects of an electro-oxidation separation system with electrode reaction chemistry, in accordance with some aspects of the present technology. As will be appreciated, hydroxyl radical production chemistry is implemented for the separation and removal of WSOs from an aqueous stream. Hydroxyl radicals have high oxidation potential for organics removal and can be generated in situ and instantly in a vessel or pipe flow (e.g. from reaction with electrodes, such as coated electrodes described herein) without the addition of other chemicals.

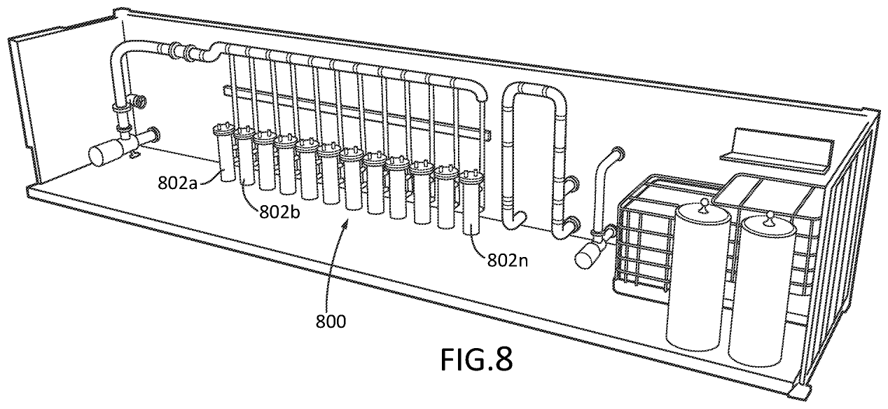

FIG. 8 illustrates a diagram of an example electro-oxidation system 800, in accordance with some aspects of the present technology. As will be appreciated, in system 800, multiple EO units 802a, 802b, 802n are implemented in parallel for WSO removal and/or separation.

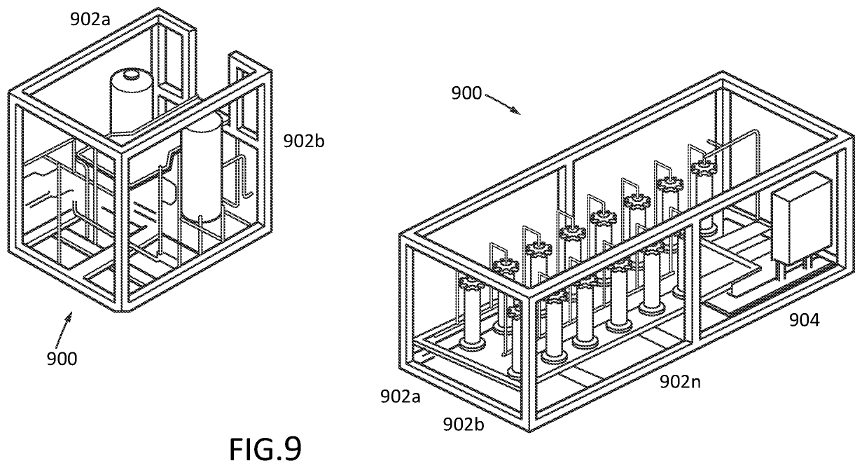

FIG. 9 illustrates example electro-oxidation systems 900, in accordance with some aspects of the present technology. EO systems 900 can incorporate one or more EO units 902a, 902b, 902n, and further can be arranged on a skid. As will be appreciated, compact arrangement on a skid can be implemented to reduce the overall footprint of an EO system. Further, a EO system arranged on a skid can additionally incorporate a control panel 904 and/or electrical system (e.g. for polarity reversal of any of the electrodes or electrode arrays, for instance anodes and cathodes are configured such that their polarity is switchable) directly thereon.

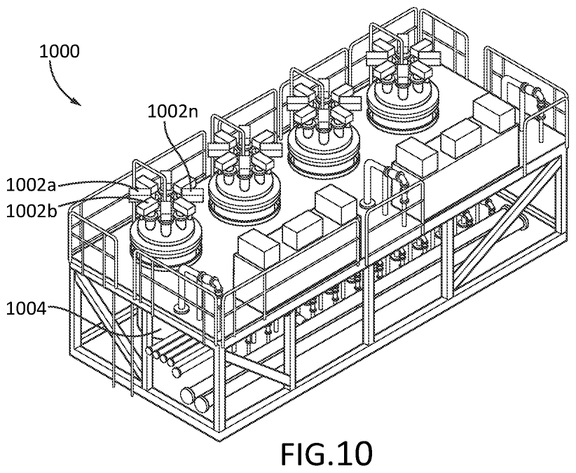

FIG. 10 illustrates an example electro-oxidation system 1000, in accordance with some aspects of the technology described herein. In some instances, system 1000 can include one or more EO units 1002a, 1002b, 1002n, which can be contained in a larger housing. 1004. As will be appreciated, each EO unit can be connected to its own power source. In some further aspects, each EO unit can be contemplated as a cartridge which can be changed or swapped.

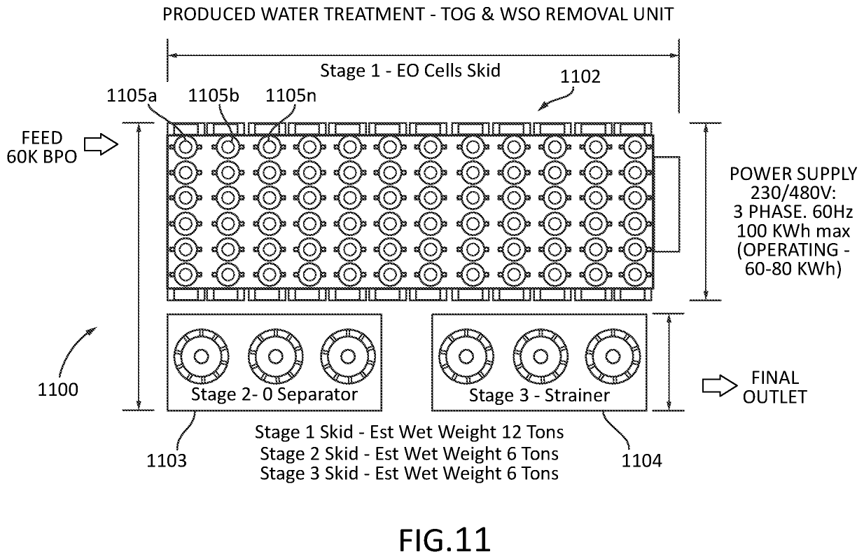

FIG. 11 illustrates an example schematic of a produced water treatment (Total Oil and Gas and WSO Removal Facility) system 1100, in accordance with some aspects of the present technology. As illustrated, system 1100 can include multiple stages, for example EO cell stage 1102, separator stage 1103, and strainer stage 1104. EO cell stage can include one or more EO units, 1105a, 1105b, 1105n.

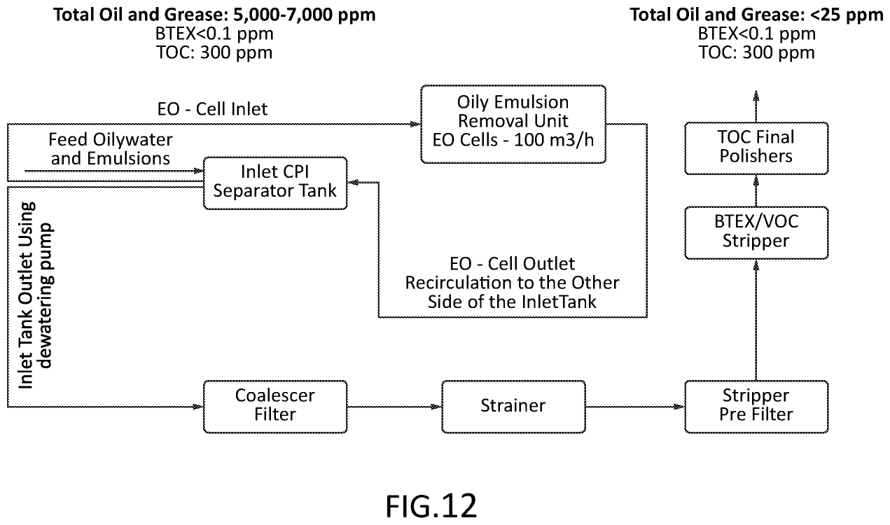

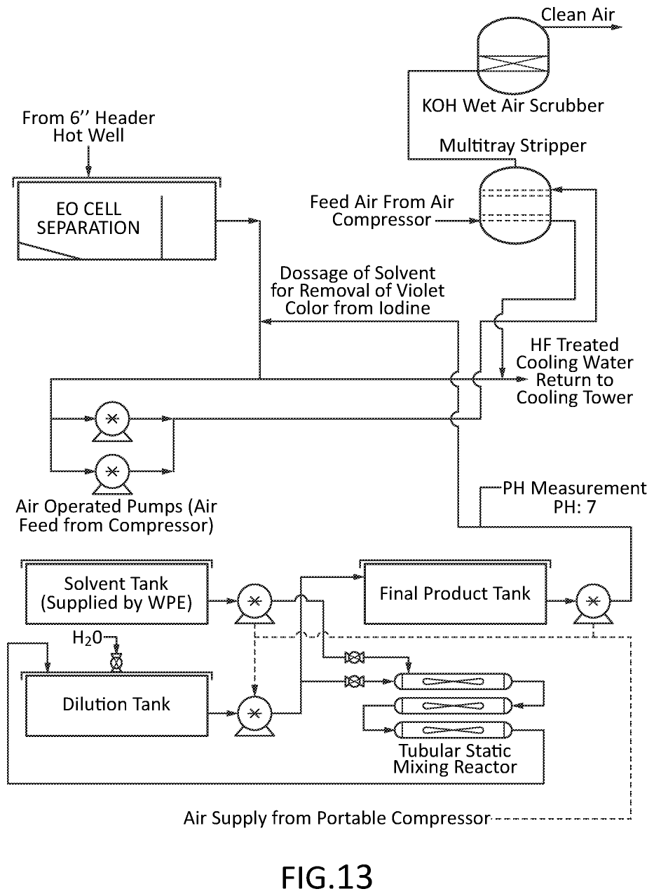

Referring briefly to FIG. 12 and FIG. 13, example configurations of a produced water treatment system are illustrated, incorporating one or more separation and/or removal units comprising one or more EO units or cells.

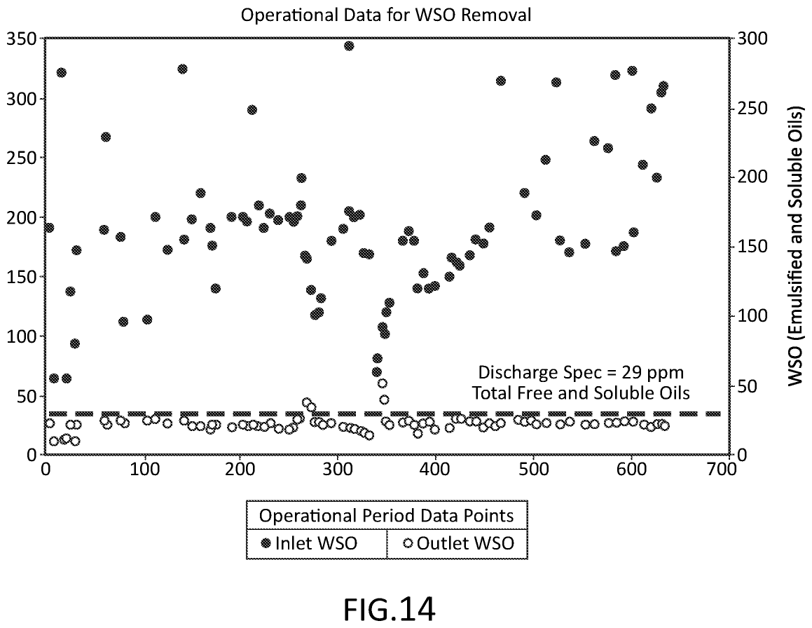

FIG. 14 graphically illustrates WSO removal implementing electro-oxidation systems, in accordance with some aspects of the present technology. As shown, implementing EO units or cells in accordance with aspects described herein enables significant reduction in WSOs from aqueous streams.

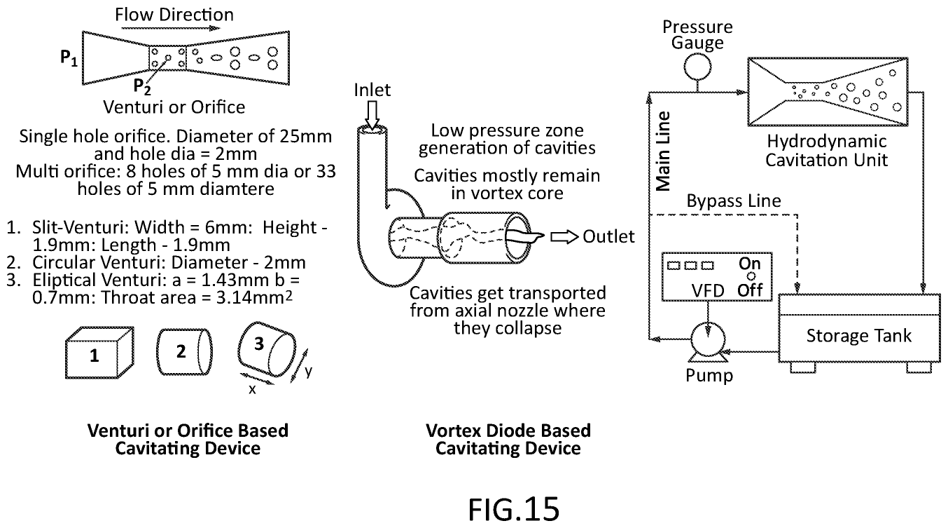

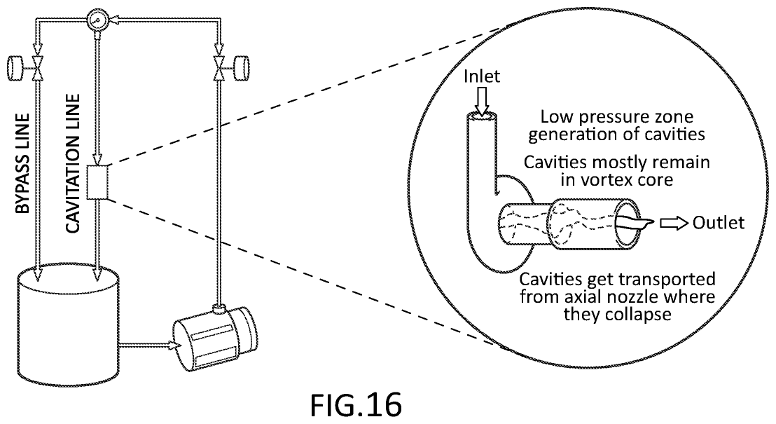

In some aspects, systems described herein can further incorporate hydrocavitation (HC) units. FIG. 15 and FIG. 16 illustrate various aspects and implementation of an HC unit. In some aspects, an HC unit can be implemented to generate and/or create microbubbles in any portion or segment of an aqueous stream. In some instances, an HC unit can additionally generate hydroxyl radicals through pressure and/or temperature release. In some instances, the incorporation of an HC unit can increase flow capacity within the system, reduce energy intensity and usage (e.g. reduce mA/cm²) across the electrodes, and alter timing of an aqueous stream through the system, thereby improving efficiency of WSO removal.

### CLAUSES

Certain implementations of systems and methods consistent with the present disclosure are provided as follows:
Clause 1. A system for removing water soluble organics from an aqueous stream, comprising: an electro-oxidation (EO) unit comprising: a titanium anode comprising a mixed metal oxide (MMO) coating; a titanium cathode; a channel between the anode and the cathode; and a power source configured to apply electricity across the channel.
Clause 2. The system of clause 1, an electrode array comprising a plurality of anodes and a plurality of cathodes.
Clause 3. The system of clause 2, wherein the system is formed into a cartridge.
Clause 4. The system of clause 1, wherein the MMO coating is iridium oxide.
Clause 5. The system of clause 1, wherein the MMO coating comprises iridium oxide, ruthenium oxide, tantalum oxide, and platinum oxide.
Clause 6. The system of clause 1, wherein the titanium cathode comprises an MMO coating.
Clause 7. The system of clause 6, wherein the MMO coating is iridium oxide.
Clause 8. The system of clause 6, wherein the MMO comprises iridium oxide, ruthenium oxide, tantalum oxide, and platinum oxide.
Clause 9. The system of clause 1, wherein a voltage of 5-10 V is applied across the channel.
Clause 10. The system of clause 1, wherein a current of 10-25 amps is applied across the channel.
Clause 11. The system of clause 1, wherein a polarity of the anode and the cathode can be switched.
Clause 12. The system of clause 1, wherein 10-70 mA/cm² is applied to the anode and cathode.
Clause 13. The system of clause 1, wherein a gap between the anode and the cathode is from about 2 mm to about 60 mm.
Clause 14. The system of clause 2, wherein the electrode array comprises 2 to 100 anodes and cathodes.
Clause 15. The system of clause 1, wherein a residence time in the electro-oxidation unit is between about 30 seconds to about 4 minutes.
Clause 16. The system of clause 1, further comprising a hydrocavitation unit.
Clause 17. The system of clause 1, further comprising a plurality of EO units.
Clause 18. The system of clause 17, wherein a portion of the plurality of EO units have a reversed polarity.

Clause 19. The system of clause 1, wherein the cathode is one of Ti, MMO coated Ti, and/or Ti Boron doped diamond film coated and the anode is one of Ti, MMO coated Ti, and/or Ti Boron doped diamond film coated.
Clause 20. A method for removing water soluble organics from an aqueous stream, comprising: contacting a system of clause 1 with an aqueous stream or a portion of an aqueous stream from another process, wherein the aqueous stream comprises WSOs; and removing at least a portion of the WSOs from the aqueous stream.

### EXAMPLES

Aspects of the technology described herein can be further understood with reference to the following non-limiting examples.

Onsite Oily Wastewater Treatment Operating at 1-500 m³/h

| Influent Parameters | Feed | | Outlet | |
|---|---|---|---|---|
| Oils | 10,000-50,000 | ppm | 0-10 | ppm |
| Benzene, Toluene, Ethyl, | 100-5,000 | ppm | 0.01-0.16 | ppm |
| Xylene, Styrene, VCM, EDC, | | | | |
| VOCs | | | | |
| TOC/COD | 1,000-50,000 | ppm | 20-800 | ppm |
| TDS (as option to recycle) | 5,000-25,000 | ppm | 100-2000 | ppm |
| Ammonia (free and dissolved) | 100-5,000 | ppm | 1-100 | ppm |
| Sulfides and Mercaptans | 100-60,000 | ppm | 0.05-1 | ppm |

Onsite Spent Caustic Treatment Operating at 1-20 m³/h

| Influent Parameters | Feed | | Outlet | |
|---|---|---|---|---|
| Sulfides, hydrosulfides, | 10,000-60,000 | ppm | 0.01-1 | ppm |
| polysulfides, and Mercaptans | | | | |
| (total sulfur) | | | | |
| TOC/COD | 1,000-50,000 | ppm | 50-200 | ppm |
| TDS (as option) | 30,000-60,000 | ppm | 100-1,000 | ppm |

| | | |
|---|---|---|
| pH | 12-14 | 6-9 |

### Onsite Produced Water Treatment Operating at 100-500 m³/h

| Influent Parameters | Feed | | Outlet | |
|---|---|---|---|---|
| Strong oily water emulsions, | 50-1000 | ppm | 0-10 | ppm |
| Water Soluble Organics | | | | |
| (emulsified) | | | | |
| TSS Removal | 0.1-100 | microns | 0.1-5 | microns |

### Process Water and Cooling Water Treatment—Side Stream Unit Operating at 100-2,000 m³/h

| Influent Parameters | Feed | | Outlet | |
|---|---|---|---|---|
| Turbidity | 50-100 | NTU | <10 | NTU |
| TSS Removal | 0.1-100 | microns | 0.1-5 | microns (<10 ppm) |

Embodiments described herein can be understood more readily by reference to the embodiments and examples described above. Elements, apparatus, and methods described herein, however, are not limited to any specific embodiment presented in the Examples. It should be recognized that these are merely illustrative of some principles of this disclosure, and are non-limiting. Numerous modifications and adaptations will be readily apparent without departing from the spirit and scope of the disclosure.

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and subcombinations and are contemplated within the scope of the claims.

1. A system for removing water soluble organics from an aqueous stream, comprising:
an electro-oxidation (EO) unit comprising:
a titanium anode comprising a mixed metal oxide (MMO) coating;
a titanium cathode;
a channel between the anode and the cathode; and
a power source configured to apply electricity across the channel.

2. The system of claim 1, an electrode array comprising a plurality of anodes and a plurality of cathodes.

3. The system of claim 2, wherein the system is formed into a cartridge.

4. The system of claim 1, wherein the MMO coating is iridium oxide.

5. The system of claim 1, wherein the MMO coating comprises iridium oxide, ruthenium oxide, tantalum oxide, and platinum oxide.

6. The system of claim 1, wherein the titanium cathode comprises an MMO coating.

7. The system of claim 6, wherein the MMO coating is iridium oxide.

8. The system of claim 6, wherein the MMO comprises iridium oxide, ruthenium oxide, tantalum oxide, and platinum oxide.

9. The system of claim 1, wherein a voltage of 5-10 V is applied across the channel.

10. The system of claim 1, wherein a current of 10-25 amps is applied across the channel.

11. The system of claim 1, wherein a polarity of the anode and the cathode can be switched.

12. The system of claim 1, wherein 10-70 mA/cm² is applied to the anode and cathode.

13. The system of claim 1, wherein a gap between the anode and the cathode is from about 2 mm to about 60 mm.

14. The system of claim 2, wherein the electrode array comprises 2 to 100 anodes and cathodes.

15. The system of claim 1, wherein a residence time in the electro-oxidation unit is between about 30 seconds to about 4 minutes.

16. The system of claim 1, further comprising a hydrocavitation unit.

17. The system of claim 1, further comprising a plurality of EO units.

18. The system of claim 17, wherein a portion of the plurality of EO units have a reversed polarity.

19. The system of claim 1, wherein the cathode is one of Ti, MMO coated Ti, and/or Boron doped diamond film coated TI and the anode is one of Ti, MMO coated Ti, and/or Boron doped diamond film coated Ti.

20. A method for removing water soluble organics from an aqueous stream, comprising:
contacting a system of claim 1 with an aqueous stream or a portion of an aqueous stream from another process, wherein the aqueous stream comprises WSOs; and
removing at least a portion of the WSOs from the aqueous stream.
